(19) United States
(12) Patent Application Publication
(10) Pub. No.: US 2006/0250273 A1
(43) Pub. Date: Nov. 9, 2006

(54) Graphical interface system

(76) Inventors: Mark Milner, White Lake, MI (US); Alfonso Albaisa, Chula Vista, CA (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/325,706

(22) Filed: Jan. 5, 2006

Related U.S. Application Data
(60) Provisional application No. 60/642,451, filed on Jan. 7, 2005.

(51) Int. Cl. G01V 3/00

(52) U.S. Cl. 340/854.1

(57) ABSTRACT

A graphical interface system including a screen; a data receiving device capable of receiving positioning information concerning the physical position or performance of the system or a related apparatus; and memory for storing data relating to one or more real-world routes, courses or tracks.

### CROSS REFERENCE TO RELATED APPLICATION

This application is related to co-pending U.S. Provisional Patent Application entitled “Graphical Interface System” filed on Jan. 7, 2005 and accorded Ser. No. 60/642,451, which is entirely incorporated herein by reference.

### TECHNICAL FIELD

The invention relates to a graphical interface system, including a system that can be used in connection with a vehicle.

### BRIEF DESCRIPTION OF THE DRAWINGS

In the exemplary drawings:

FIG. 1 illustrates an embodiment of a graphic interface system in which the display screen is in a substantially “closed” configuration.

FIGS. 2 through 6 illustrate embodiments of a display screen in various “open” or “user-viewable” configurations.

### DETAILED DESCRIPTION

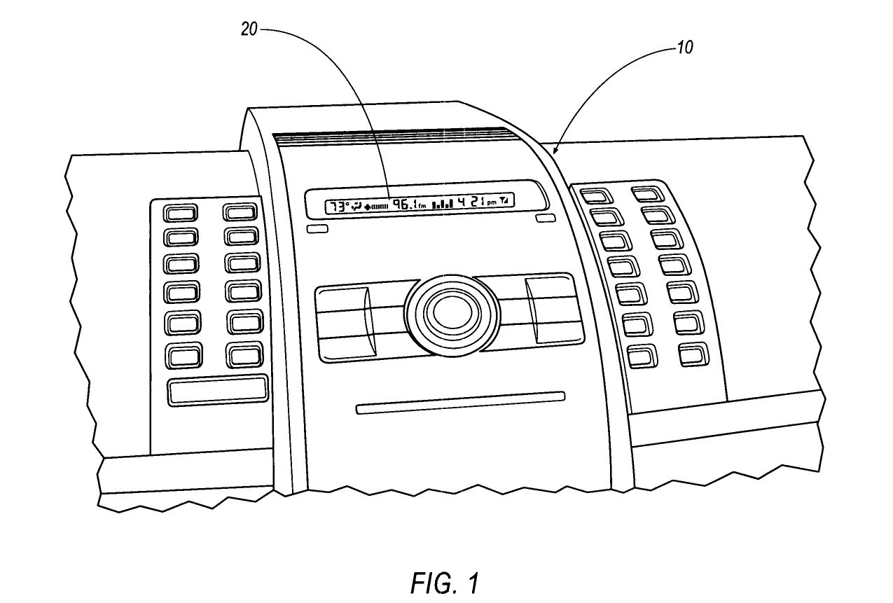

Turning to an embodiment of the invention, FIG. 1 depicts a system 10 that is, for example, incorporated into a vehicle dashboard. However, the system is not limited to the position shown, and may be positioned differently or located in many other locations within a vehicle.

System 10 includes a display screen 20 that may be retractable. FIG. 1 illustrates the screen in a possible configuration in which only a portion of the screen 10 is viewable. In such an embodiment, when the screen is substantially retracted from view, the system 10 can provide certain manufacturer or user-selected/specified information (e.g., “primary information”) to a user. For example, a portion of the illustrated screen presents, among other information, the current temperature (73°), radio station (96.1), and time (4:21). However, it is noted that, if desired, the entire screen, including the “primary information”, may be completely hidden from view.

The system may include an information or data interface for communicating data into and/or exporting data from the system; and/or connectivity to a worldwide computer network, such as the Internet. In an embodiment of the system, the system has the ability to receive and utilize real-time or substantially real-time global positioning system (GPS)-type information and data.

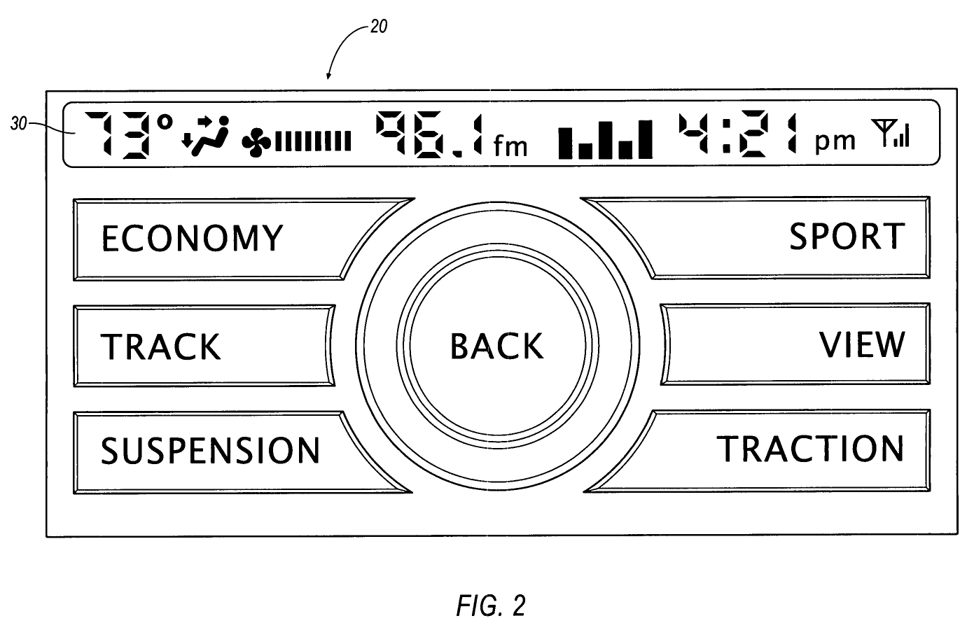

FIG. 2 illustrates an embodiment of a portion of a screen 20 in a viewable configuration. In this embodiment, certain primary information (generally identified as row 30) may remain viewable or may disappear from view. If it is desired for the primary information 30 to remain viewable, it can be shown in other formats and/or positioned at other locations on the screen 20 than that depicted. For example, if desired, the primary information 30 can remain in a location consistent with it viewable location in connection when in a substantially retracted position (such as shown for example in FIG. 1) by being moved or scrolled to the same or substantially the same viewing position. Further, the screen may be touch-sensitive and/or voice activated and user-controlled.

The example screen 20 shown in FIG. 2 may include a number of options and/or menu-type controls that a user may select. FIG. 2 illustrates just a few potential options and controls that may be available.

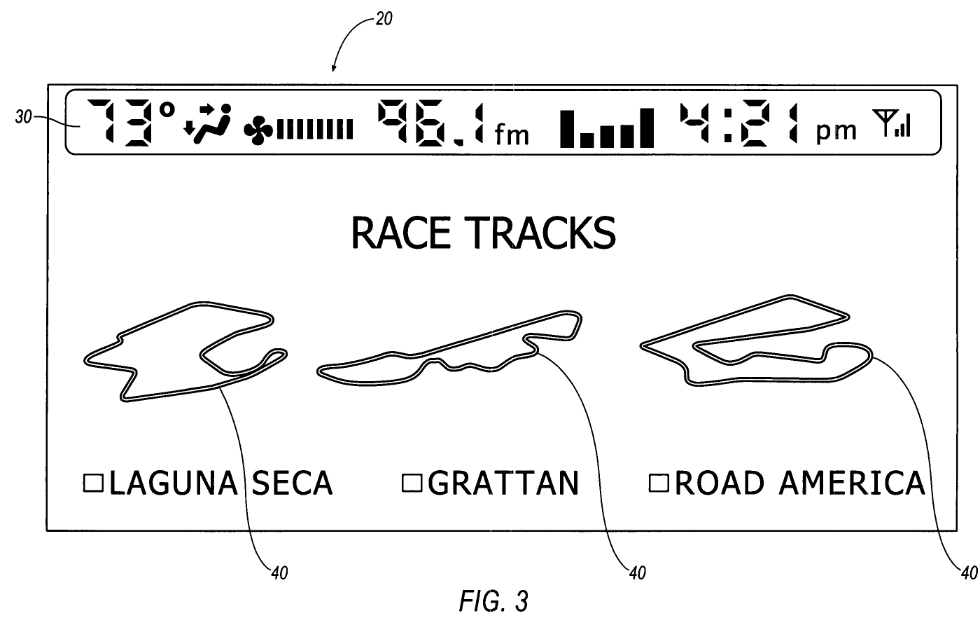

For example, in an embodiment, a user may view the screen output shown in FIG. 2 and select “TRACK.” The screen may then, for example, change to another screen output (such as for example shown in FIG. 3) that includes one or more pre-defined routes, courses or tracks 40, such as a race track, for which the system 10 has real-world-physical or geographic data or information available. The user may be shown several routes, tracks or courses in the physical world that may be available for use/interaction in connection with the system. Alternatively, in some embodiments, the system 10 may record and “learn” routes, such as by recording and manipulating GPS data provided to the system. Additional routes, courses, or tracks can also be electronically uploaded into the system.

When employed in a vehicle environment, such as in an automobile, the user may select a specific route, course, or track that coincides with the users physical environment. For instance, if the user selects a specific course or track 40 (such as the second (middle track) (“Grattan”) in the screen output shown in FIG. 3), the system 10 can then monitor the position of the system 10 (or the associated vehicle) relative to or within the real-world course or track 40.

Moreover, the system can, if desired, confirm that the user is at or sufficiently proximate the selected course or track and accept real-world positioning data (such as GPS data for the location of the vehicle). In an embodiment, the system can be set such that certain interactive screen functions will only work when the system/vehicle is in motion on the physical route, course, or track that is visually represented on the screen. Moreover, as describe further herein, the system can calculate and/or provide various desired information concerning the system/vehicle and its location and/or performance.

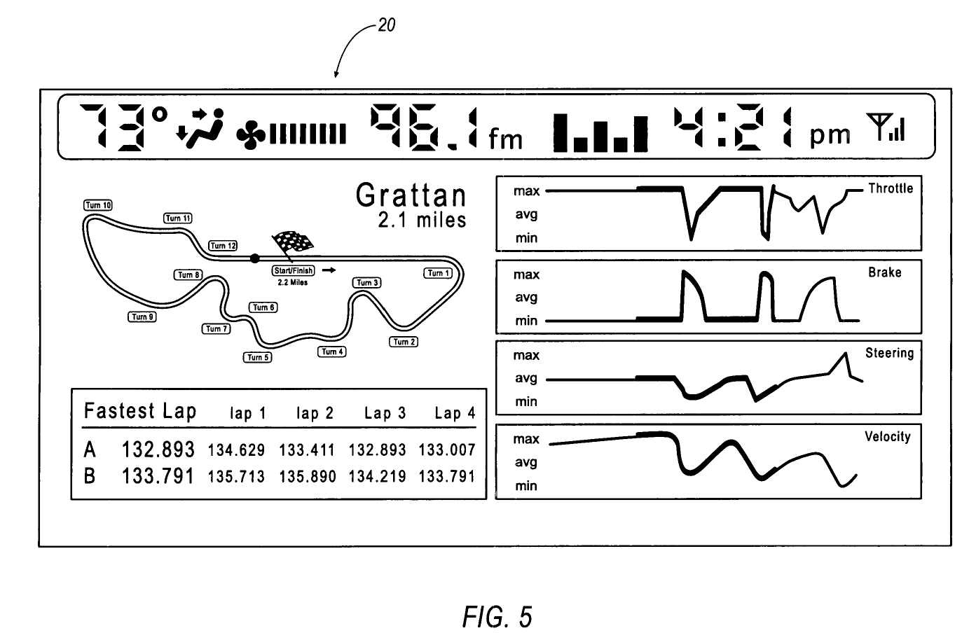

To the extent desired, the system 10 can monitor the real world position of the system/vehicle with respect to the virtual embodiment of the selected and associated route, course, or track. FIG. 5 illustrates a virtual or electronic representation of an exemplary route, course or track 40. The white circular dot 30 (positioned just left of the labeled “Start/Finish”) represents the current physical real-world position of the system or vehicle in its real-world position on the track and is depicted in a corresponding virtual relative position on the select virtual track. The virtual representation of the associated route, course or track 40 can include further information (such as, for example, its length) and identifiers (such as various points or landmarks (e.g., turns or straight-aways) associated with the route, course or track).

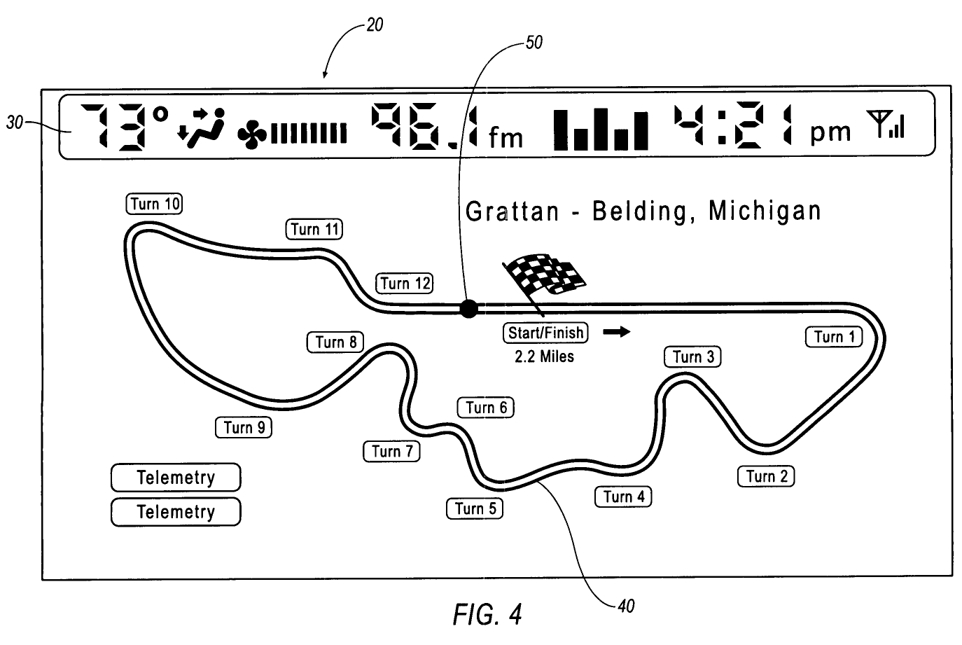

The system can provide the user with further select “menu” options. For example, the user may want to view various metrics associated with the real-world position and performance of the system or vehicle and may select such an option, for example, without limitation, the “Telemetry” or “Records” options shown in FIG. 4.

FIG. 5 illustrates just some of the metrics that can be visually provided by the system 10. Such metrics can include, for example, and without limitation, lap speeds, fastest laps, throttle data, braking data, steering data, velocity/speed data, fuel economy, aerodynamic information, and various other forms of function or performance data or information that may be of interest. Moreover, graphical representations (for example, as generally shown in FIG. 5) can be included in the visual output as desired.

The system 10 also permits the recording, capture, storage and transmission of various types of system-related information or performance records. Such records can be stored in connection with the system (whether on the system or remotely) and can be transmitted to other systems (such as, for example, a network, computer, or processing unit) by various means of data transmission/communication, including memory storage devices (such as a card) or through various forms of remote data transmission/communication.

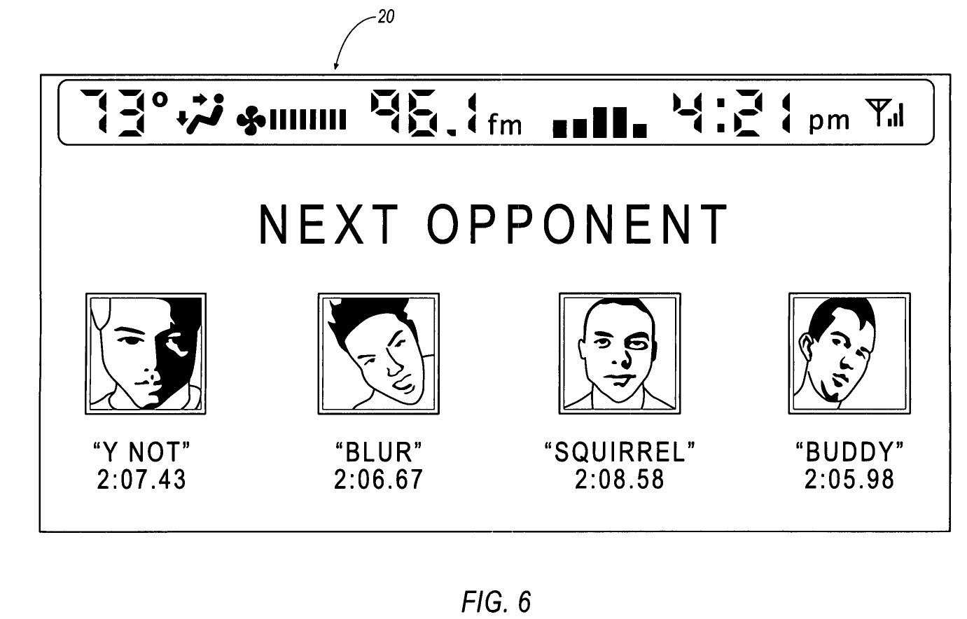

The records or data from the system 10 can be used in other environments, including other virtual environments (e.g., the electronic or “home-gaming”60 environment). Further, such records can be transferred or shared/compared with other users. For example, FIG. 6 illustrates a sample screen output with representations of certain other users (or “opponents”). The system 10 can further include information concerning such other users, for instance, a user's “best time” on the same route, course, or track.

In an embodiment of the invention, the user's data—taken from its real-world performance—as captured and recorded by the system, can be provided to and used in connection with a gaming system. To the extent desired, the gaming system can make use of such information and/or data in connection with an associated virtual game.

Additionally, the system 10 may optionally include data/statistics, “ghost” images or other representations of an individuals (or another individuals) performance on the screen. For example, a positional reference identifier or the performance characteristics of a world-class racer on the same route, course or track may be shown on the screen 20 along with the current user. Such information could also be included in connection with remote “gaming” programs.

What is claimed is:

1. A graphical interface system including:
a screen;
a data receiving device capable of receiving positioning information concerning the physical position or performance of the system or a related apparatus; and
memory for storing data relating to one or more real-world routes, courses or tracks.
